(19) United States
(12) Patent Application Publication
(10) Pub. No.: US 2010/0162185 A1
(43) Pub. Date: Jun. 24, 2010

(54) ELECTRONIC CIRCUIT DESIGN

(75) Inventor: Adrian Dominic Thompson, Sussex (GB)

Correspondence Address: Vierra Magen Marcus & DeNiro LLP, 575 Market Street, Suite 2500, San Francisco, CA, 94105, US

(73) Assignee: UNIVERSITY OF SUSSEX, Brigthton (GB)

(21) Appl. No.: 12/063,501

(22) PCT Filed: Aug. 11, 2006
(86) PCT No.: PCT/GB2006/002994

§ 371 Date: Feb. 11, 2008

(30) Foreign Application Priority Data
Aug. 12, 2005 (GB) 0516634.3

(51) Int. Cl. G06F 17/50

(52) U.S. Cl. 716/2

(57) ABSTRACT

A system for optimising electronic circuits to be designed has two parts or phases, a training phase 10 in which optimisation scenarios for selected electronic circuits are derived using an evolutionary algorithm, and an operation phase 11, in which the derived optimisation scenarios are used to optimise new electronic circuits to be designed. The training phase 10 uses an evolutionary algorithm to produce a specialised and relatively fast optimisation scenario for each of a plurality of input circuits or groups of circuits (step 13). One or more of the evolved specialist optimisation scenarios are then selected to form a suite of optimisation scenarios (step 15) for use to optimise new circuits to be designed. In the operation phase 11, a new circuit to be optimised is input at step 18, and a plurality of optimisation scenarios from the suite of optimisation scenarios 15 is then used to try to optimise the new circuit (step 19). The best optimisation result is taken as the optimisation for the circuit (step 20).

The present invention relates to the design of electronic circuits, and in particular, although not exclusively, to the optimisation of digital electronic circuits.

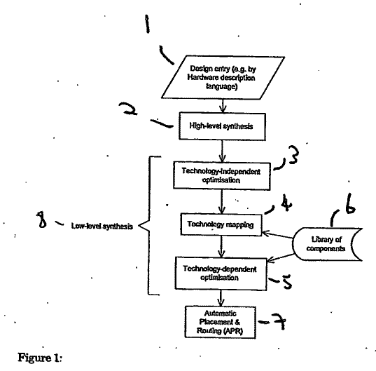

The design of electronic circuits is often aided by the use of e.g. software, tools that automate and aid some or all of the design process. FIG. 1 shows schematically steps of an exemplary such “electronic design automation” (EDA) process. For each step shown in FIG. 1, a software tool, for example, will be used to aid or execute the design process.

In a design process such as that shown in FIG. 1, the main, initial input from the user is a high-level specification for the desired circuit (step 1). This specification may be set out as schematics (circuit diagrams) or more typically described using a hardware description language. The high-level specification may also, e.g., refer to pre-designed circuits or sub-systems.

The next stage in the design process is so-called high-level synthesis (step 2). This transforms the input high-level specification into a form almost ready to be mapped onto networks of electronic components. This high-level synthesis includes, for example, assigning tasks to particular circuit modules and scheduling how these will be used.

There is then a series of processes that are commonly collectively referred to as “low-level” synthesis 8. This low-level synthesis transforms the results of the high-level synthesis into a form that can be built using the chosen fabrication technology (usually some form of integrated circuit).

The first such low-level synthesis process is technology-independent optimisation (step 3). This process aims to simplify the design as much as possible, but still at the level of abstract logic, rather than a network of physical components of the technology. Technology-independent optimisation typically manipulates directed acyclic graphs (DAGs) at the nodes of which are Boolean equations. Simplifications to this network of logic usually result in smaller physical circuits.

The next stage is technology mapping (step 4) which maps the design onto the components available in the chosen fabrication technology. There is then a technology-dependent optimisation step (step 5) which attempts to perform further optimisations. Both these steps use a library of components 6.

The final stage is then a step of automatic placement and routing of the components (step 7), which attempts to find good physical locations for the components and routes for the connections between them.

As will be appreciated by those skilled in the art, the above is a simplified description of an electronic circuit design flow, and thus variations and modifications to the described process can and do exist. It can also be the case, for example, that there are not such clear divisions between the steps as is shown in FIG. 1, and also that the process can and will backtrack to reconsider decisions made earlier at a higher level. There may also be (and indeed there typically will be) considerations beyond those shown, such as design verification and the ease with which the final circuit can be adequately tested in its manufacture and application (its “testability”).

A key aspect of an electronic circuit design process of this nature is the automated optimisation processes that take place at many of the stages in the design flow. Such optimisations typically relate e.g., to minimising the size of the resulting circuit (since this will reduce the cost and the silicon footprint of the circuit), but can also or instead relate, e.g., to the speed of circuit operation, the circuit's power consumption, the circuit's testability, etc.

An example of an optimisation criterion used for technology-independent optimisation is to minimise the sum of the literals in factored form in the directed acyclic graph of Boolean functions that represents the circuit. This criterion provides a measure of the overall complexity of the logic in the directed acyclic graph of Boolean functions that represents the circuit and minimising it can lead to smaller physical circuits with acceptable delay characteristics. Optimisation by this criterion is often found to be useful, even if other more application-specific optimisations are to be performed afterwards. An optimisation process for optimising this criterion will typically specify a process for minimising the sum of the literals in factored form in the directed acyclic graph of Boolean functions that represents the circuit.

The optimisation processes used in electronics design automation tools can include many steps, and sequencing these steps and setting their parameters can be a difficult problem. A specification of the optimisation steps to be carried out is typically referred to as an optimisation scenario or script. An optimisation scenario can be thought of as specifying the multiple processes of transformation which together improve the quality of an electronic circuit design according to desired optimisation criteria. An optimisation script is one example (form) of an optimisation scenario. The optimisation scenarios (e.g. scripts) can then be built into the software design tool and used as an optimisation process during the circuit design process.

A commonly used and well-known electronic design automation tool is the Berkeley SIS system developed by the University of California, Berkeley. In the SIS system, optimisation scenarios are configured as scripts that set out the steps of the optimisation process and that are supplied as a text file to the SIS software.

One known way to derive an optimisation scenario for use in circuit design is to manually analyse and assess different optimisation scenarios. This has led to the development of a number of known, standard, optimisation scenarios (scripts) that have been found to optimise nearly all circuits well. These optimisation scenarios may be referred to as “general purpose” scenarios or scripts. A number of such general purpose optimisation scenarios have been developed for the SIS system, for example.

It is also known to try to derive more specialised optimisation scenarios, e.g. that are tailored to optimise one particular circuit (and better than a more general purpose scenario would). This is typically done through manual experimentation, starting from a known general-purpose scenario.

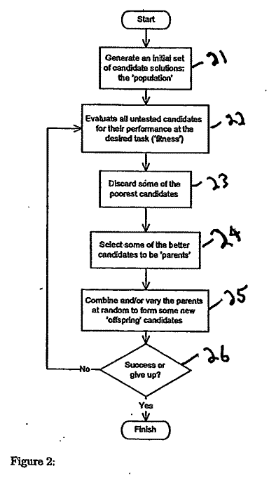

It has also been proposed to use a so-called evolutionary (or genetic) search algorithm, for example of the type shown in FIG. 2, to test and optimise an optimisation scenario. It has been found that such evolutionary algorithms can be used to derive optimisation scenarios that will perform better for a given target circuit than a more general purpose optimisation scenario that has been designed by a human expert.

In arrangements where evolutionary algorithms are used to produce an optimisation scenario for a given circuit, it is, as will be appreciated by those skilled in the art, necessary to “evolve” the optimisation scenario before it can be used as a tool for optimising the circuit in question. Thus, the overall optimisation process can be viewed as having two parts, a first, “training” phase, in which the evolutionary algorithm is used to produce an optimisation scenario for the circuit in question, and a second “operation” phase, in which the evolved optimisation scenario produced by the training phase is applied to the circuit to be optimised to optimise that circuit. In other words, the evolutionary algorithm is first used to produce the optimisation scenario, and the evolved scenario is then used as a tool to optimise a circuit to be optimised.

A drawback with the evolutionary derivation of more specialised optimisation scenarios is that such evolutionary derivation is a time and computing resource intensive process (since the process involves evaluating many different possible candidate optimisation scenarios). This effort may be justified where the circuit to be optimised is of particular importance or effect, but means that it is not really practicable to try to evolve specialised optimisation scenarios for each and every circuit that might be encountered.

The use of evolutionary algorithms to generate general purpose scenarios that will optimise a range of circuits is also not generally carried out because of the far greater computational effort and time that this would require, and the difficulty of surpassing manually-derived scenarios in the general case.

This all means that in practice circuit design systems tend to use more general purpose, manually derived, scenarios for their optimisation scenarios.

The Applicants believe that there remains scope for improvement to automated tools and processes for use in the design of electronic circuits.

According to a first aspect of the present invention, there is provided a method of producing a suite of optimisation scenarios for use in the automated design of electronic circuits, comprising:

using an evolutionary algorithm or algorithms to evolve an optimisation scenario for each of a plurality of different electronic circuits; and

including one or more of the optimisation scenarios evolved for the different circuits in a suite of optimisation scenarios for use to optimise electronic circuits during their design.

According to a second aspect of the present invention, there is provided an apparatus for producing a suite of optimisation scenarios for use in the automated design of electronic circuits, comprising:

means for using an evolutionary algorithm or algorithms to evolve an optimisation scenario for each of a plurality of different electronic circuits; and

means for providing one or more of the optimisation scenarios evolved for the different circuits as a suite of optimisation scenarios for use to optimise electronic circuits during their design.

According to a third aspect of the present invention, there is provided a suite of optimisation scenarios for use to optimise electronic circuits during their design, comprising:

a plurality of optimisation scenarios that have been derived by using an evolutionary algorithm or algorithms to evolve an optimisation scenario for each of a plurality of different electronic circuits.

In the present invention, evolutionary algorithms are used to derive optimisation scenarios for a number of different circuits. The so-evolved optimisation scenarios are then provided as a suite (set) of optimisation scenarios for use to optimise new circuits to be designed.

The Applicants have found that deriving a set of evolved optimisation scenarios in this manner can provide a set of optimisation scenarios that will, e.g., provide better optimisation, of new circuits during circuit design than, e.g. known, more general purpose optimisation scenarios, but without the need, e.g., to derive an optimisation scenario using an evolutionary algorithm for each and every circuit that will be or may be anticipated to be encountered.

In particular, the Applicants have found that an optimisation scenario specifically evolved for a given circuit (a specialist scenario) will not only perform well for its target circuit, but will also tend to perform better for some other circuits as well. These other circuits can be thought of as “auxiliary” circuits of the optimisation scenario. The Applicants have further recognised that by developing a suite of plural specialist optimisation scenarios, each with their own set of auxiliary circuits, then the combination of the specialist scenarios together with their sets of auxiliary circuits can provide a set of optimisation scenarios that can and will cover many, if not all, of the circuits that might be encountered, and without the need to evolve a specialist optimisation scenario for each and every individual circuit that might be encountered. Indeed, the Applicants have found that it is possible to achieve excellent performance on many circuits using a suite of only a few specialist optimisation scenarios.

The circuits for which optimisation scenarios are evolved can be selected as desired. For example, scenarios could be evolved for one or more (selected) circuits taken from known, reference, or benchmark sets of circuits that are typically used in electronics design automation tools. However, this is not essential, and other, e.g., non-benchmark, circuits could be and preferably are also or instead used. For example, optimisation scenarios could be evolved for a new, unknown circuit or circuits, e.g., that are of particular interest.

The circuits for which optimisation scenarios are evolved could, e.g., be selected at random. However, in a preferred embodiment, scenarios are evolved for circuits for which it is recognised that known, standard scenarios have difficulty optimising. Preferably scenarios are preferentially evolved for circuits that are harder to optimise. It would also, e.g., be possible to (and, indeed, is preferred to) select the circuits on the basis of, e.g., the existing suite of optimisation scenarios (and, e.g., any identified weaknesses in that suite).

In a preferred embodiment, a set of plural different electronic circuits to be evaluated (i.e., for which optimisation scenarios will be evolved) is selected. In one preferred embodiment optimisation scenarios are evolved for 5 to 15, most preferably 10, circuits.

In a preferred embodiment, a set of plural individual circuits may be grouped together and a single optimisation scenario evolved for that group of circuits. This would allow, for example, the production of an optimisation scenario that is specialised for a particular class of circuits. This may be useful where, e.g., a particular type or class of circuit can be represented by a (small) group of individual circuits that can all be tested during evolution of the optimisation scenario.

It would also be possible, e.g., to evolve plural optimisation scenarios for the same circuit or group of circuits (and to include, e.g., all of those optimisation scenarios in the suite of optimisation scenarios to be used). As will be discussed further below, the Applicants have found that different optimisation scenarios evolved for the same circuit may still have different sets of auxiliary circuits, such that it may be useful to include both or all the optimisation scenarios in the suite (set) of optimisation scenarios to be used.

The optimisation scenario for each circuit (or group of circuits) can be evolved using any suitable evolutionary algorithm or process, such as the evolutionary techniques already known in the art. Thus, for example, an evolutionary run can begin from a population of randomly generated scenarios, or could, e.g. be seeded with scenarios that have already been evolved or designed manually. The same evolutionary algorithm may be used for each circuit, or different algorithms could be used.

As will be appreciated by those skilled in the art, the evolutionary process should target (i.e. have as selection (fitness) criteria) the optimisation criteria, such as the sum of the number of literals in factored form, that the optimisation scenario is intended to optimise. To do this, the optimisation criteria result for each candidate scenario can, e.g., be determined and then the candidate scenarios selected for further evolution or rejection, accordingly, as is known in the art.

In a particularly preferred embodiment, as well as evaluating the candidate optimisation scenarios during the evolutionary process according to their optimisation “result” as discussed above, the time taken for the scenarios to terminate (i.e., their speed of execution) is also taken into account, with quicker scenarios being preferred (e.g., preferentially selected for continued evolution and/or selection as the optimisation scenario to use). Most preferably, if the optimisation criteria measure for two or more candidate scenarios is equal, the faster terminating scenario is then preferentially chosen.

Thus, in a particularly preferred embodiment, one of the evolution criteria that is set for, and encouraged in, the evolutionary algorithm is the speed of optimisation of the scenario (i.e. how quickly the scenario will produce its optimisation results (i.e. optimise) its target circuit). This will preferentially evolve optimisation scenarios that produce relatively high quality results for their circuits, but relatively quickly. This is advantageous in use of suite of optimisation scenarios, as will be discussed further below.

In a preferred arrangement, a time limit is set for how long it takes the optimisation scenario to produce its optimisation result (i.e., to terminate), with, for example, any scenarios that exceed this time limit being, e.g., terminated at the time limit (with the optimisation result then achieved being taken as the result for the scenario), or, e.g., being rejected from further consideration. This time limit is preferably in addition to the preferential selection of faster terminating scenarios discussed above. This is preferably done at least during the early stages of the optimisation scenario's evolution. The time limit could also, e.g., be increased, rather than removed altogether, in later stages of the evolutionary process. This time limit could, e.g., be based on how long it takes a known, general purpose script to achieve its result for the circuit in question. A suitable such time limit could, e.g., be 600 seconds or less.

Limiting the time that an optimisation scenario takes to execute also facilitates the evolutionary process itself, since it will help to ensure that the optimisation scenarios can be evolved sufficiently fast for a reasonable number of them to be evolved and evaluated in a reasonable time during the evolutionary process.

It is believed that including the speed of optimisation as a criterion for the evolutionary derivation of an optimisation scenario for electronic circuit design may be new and advantageous in its own right.

Thus, according to a fourth aspect of the present invention, there is provided a method of deriving an optimisation scenario for use in the design of electronic circuits, comprising:

using an evolutionary algorithm to derive an optimisation scenario for use in the design of an aspect of an electronic circuit, wherein a criterion of the evolutionary algorithm is the speed that the optimisation scenario will take to optimise the aspect of the circuit design in use.

According to a fifth aspect of the present invention, there is provided an apparatus for deriving an optimisation scenario for use in the design of electronic circuits, comprising:

means for using an evolutionary algorithm to derive an optimisation scenario for use in the design of an aspect of an electronic circuit, wherein a criterion of the evolutionary algorithm is the speed that the optimisation scenario will take to optimise the aspect of the circuit design in use.

In a particularly preferred embodiment, as well as evaluating the candidate optimisation scenarios during the evolutionary process according to their optimisation “result” and, e.g., the time taken for them to terminate, as discussed above, the memory usage of the scenarios during their execution is also taken into account, with scenarios that use (“consume”) less memory being preferred (e.g., preferentially selected for continued evolution and/or selection as the optimisation scenario to use). Most preferably, if the optimisation criteria measure for two or more candidate scenarios is equal, the lower memory usage scenario is then preferentially chosen.

Thus, in a particularly preferred embodiment, one of the evolution criteria that is set for, and encouraged in, the evolutionary algorithm is the memory usage requirements of the scenario (e.g. how much memory resource the scenario will use or require to produce its optimisation results (i.e. optimise) its target circuit). This will preferentially evolve optimisation scenarios that produce relatively high quality results for their circuits, but will relatively less memory usage. This is again advantageous in use of suite of optimisation scenarios.

It is believed that including memory usage as a criterion for the evolutionary derivation of an optimisation scenario for electronic circuit design may be new and advantageous in its own right.

Thus, according to a sixth aspect of the present invention, there is provided a method of deriving an optimisation scenario for use in the design of electronic circuits, comprising:

using an evolutionary algorithm to derive an optimisation scenario for use in the design of an aspect of an electronic circuit, wherein a criterion of the evolutionary algorithm is the memory resources that the optimisation scenario will use when optimising the aspect of the circuit design in use.

According to a seventh aspect of the present invention, there is provided an apparatus for deriving an optimisation scenario for use in the design of electronic circuits, comprising:

means for using an evolutionary algorithm to derive an optimisation scenario for use in the design of an aspect of an electronic circuit, wherein a criterion of the evolutionary algorithm is the memory resources that the optimisation scenario will use when optimising the aspect of the circuit design in use.

It is also preferred for the evolutionary algorithm to preferentially select (for further evolution or as the optimisation scenario to use) shorter scenarios (e.g., in the event that the optimisation quality and time to execute for the scenarios are equal).

In a preferred embodiment, optimisation scenarios that span or include plural optimisation criteria or processes (that may, e.g., normally be considered separately) can be and are evolved. For example, instead of performing technology-independent optimisation in isolation, the subsequent technology mapping could also be taken into account when evolving the optimisation scenario. It is preferred that such “extended” optimisation assessment is only carried out if it does not lead to the evolutionary process and assessment taking too long to complete.

In a particularly preferred embodiment, the evolutionary algorithm or algorithms are arranged and selected such that they will evolve an optimisation scenario for a particular circuit in an acceptably short period of time. This will allow the evolutionary process to be repeated several times in an acceptably short timescale.

In a preferred embodiment, the evolutionary algorithm is allowed to evolve long scenarios, which may contain repeated sections, but are not constrained to do so. It is also preferred to remove (prune) any redundant commands from an evolved optimisation scenario (after evolution), for example by using an automated systematic set of tests to see which commands are actually necessary. In a particularly preferred embodiment both “pruned” and “non-pruned” versions of scenarios may be included in the suite of optimisation scenarios, since they may, for example, have different sets of auxiliary circuits.

In a preferred embodiment, the optimisation scenarios for a circuit or circuits are evolved in parallel, for example by performing multiple evolutionary runs on separate microprocessors running in parallel.

The evolved optimisation scenarios that are included in the suite of optimisation scenarios to be used can be selected as desired. It would be possible to include each and every one of the evolved optimisation scenarios in the suite of optimisation scenarios to be used, or less than all of them. In a preferred embodiment, a selected number of the evolved optimisation scenarios, preferably two or more scenarios, preferably 10 scenarios, are included in the suite of optimisation scenarios.

In a preferred embodiment, the evolved optimisation scenarios are assessed for inclusion in the suite of optimisation scenarios to be used, and included or not in the suite on the basis of that assessment. Such assessment can be carried out in any suitable or desired manner. For example, an evolved scenario could be used to optimise a selection of sample circuits to see if its inclusion would enhance the suite of optimisation scenarios, and/or its performance could be compared against standard manually designed scenarios. In a preferred embodiment, the performance of each scenario in a selected test-set of scenarios is evaluated and used to select a minimum number of scenarios from the test-set that will provide a desired optimisation performance, for use as the suite of optimisation scenarios.

In a particularly preferred embodiment, the evolved optimisation scenarios are assessed for inclusion in the suite of optimisation scenarios to be used on the basis of the auxiliary circuits that they can also usefully be used to optimise (i.e. the circuits other than their target circuit that they can be usefully used to optimise). It is preferred in this regard to, for this purpose, evaluate and estimate the quantity and/or type of auxiliary circuits of a scenario by testing the scenario against a (preferably predetermined) selection of sample circuits, rather than, e.g., trying to determine the scenario's full spectrum of auxiliary circuits.

For example, the number of auxiliary circuits that an optimisation scenario can be used for could be considered, and/or a comparison of a given scenario's auxiliary circuits, with the auxiliary circuits of another optimisation scenario or scenarios (for example the scenarios already included in the suite of optimisation scenarios to be used) could be made (e.g., to see whether new optimisation scenario will be a useful addition to the suite of optimisation scenarios or not).

Thus, in a preferred embodiment, the set of auxiliary circuits for an evolved optimisation scenario is assessed (e.g. estimated) and the optimisation scenario included or not in the suite of optimisation scenarios to use on the basis of that assessment.

It is believed that such an arrangement may be new and advantageous in its own right. Thus, according to an eighth aspect of the present invention, there is provided a method of selecting an optimisation scenario for inclusion in a suite of optimisation scenarios to be used in the design of electronic circuits, comprising:

deriving an optimisation scenario for a selected target electronic circuit;

assessing whether the derived optimisation scenario can be used to optimise electronic circuits other than its target circuit; and

selecting whether or not to include the optimisation scenario in a suite of optimisation scenarios for use in the design of electronic circuits on the basis of this assessment.

According to a ninth aspect of the present invention, there is provided an apparatus for selecting an optimisation scenario for inclusion in a suite of optimisation scenarios to be used in the design of electronic circuits, comprising:

means for deriving an optimisation scenario for a selected target electronic circuit;

means for assessing whether the derived optimisation scenario can be used to optimise electronic circuits other than its target circuit; and

means for selecting whether or not to include the optimisation scenario in a suite of optimisation scenarios for use in the design of electronic circuits on the basis of this assessment.

As will be appreciated by those skilled in the art, the above aspects of the invention can include any one or more of all of the preferred and optional features of the invention described herein. Thus, for example, the optimisation scenario is preferably derived using an evolutionary algorithm.

In these aspects and arrangements of the invention, the “auxiliary” circuits that an optimisation scenario derived for a particular target circuit will also usefully optimise can be determined and assessed in any desired manner. For example, the optimisation performance of the optimisation scenario for a particular, e.g., selected, set of circuits, such as each circuit in a selected benchmark or reference set of circuits, could be assessed, and if the optimisation performance of the optimisation scenario for a circuit is better than the optimisation performance of a known general purpose optimisation scenario for that circuit, then the circuit in question could be counted as an auxiliary circuit for the optimisation scenario (since it will provide improved optimisation performance for that circuit).

As well as assessing the “auxiliary” circuits of an optimisation scenario when determining whether to include it in the suite of optimisation scenarios, it is preferred to also or instead base the inclusion (or not) of an optimisation scenario in the suite of optimisation scenarios on the speed of execution of the optimisation scenario (as discussed above), with, e.g., faster scenarios preferentially, and/or only those scenarios that terminate faster than a selected, preferably predetermined, time limit, being included in the suite of optimisation scenarios to use.

Thus, as will be appreciated from the above, the present invention preferably involves a step of or means for selecting one or more of the evolved optimisation scenarios for inclusion in the suite of optimisation scenarios to be used, for example of the basis of the “auxiliary” circuits that will also be optimised by each optimisation scenario. Such selection may, e.g., typically mean that less than all the evolved optimisation scenarios are included in the suite of optimisation scenarios to be used, but it would equally still be possible for such selection to result in all the evolved optimisation scenarios being used.

In a preferred embodiment, it is possible to select for inclusion in the suite of optimisation scenarios an optimisation scenario or scenarios from part way through an evolutionary run, as well as or instead of the final, evolved optimisation scenario of the evolutionary run. The Applicants have found that optimisation scenarios from part way through an evolutionary run may have different, and indeed, more useful set of auxiliary circuits than, e.g., the final result that is fully honed to its target circuit.

In a preferred embodiment, the suite of optimisation scenarios can and preferably does include other optimisation scenarios in addition to the scenarios evolved for the specified, selected target circuits. Such additional optimisation scenarios could include, for example, standard, previously determined and/or manually-derived, general purpose optimisation scenarios, and/or even evolved general purpose optimisation scenarios (if available). Including existing, known, standard manually-designed general purpose scenarios in the suite of optimisation scenarios would ensure, for example, that the quality of optimisation achieved with the suite of optimisation scenarios should be no worse than that achievable when using the standard, general purpose scenarios on their own.

Where additional optimisation scenarios are included in the suite of optimisation scenarios in this manner, it is preferred that additional scenarios are only included if they can operate sufficiently quickly when being used to optimise a given circuit (i.e. their speed of optimisation is sufficiently fast, e.g., is below a selected time limit).

In a preferred embodiment, the optimisation scenarios in the suite of optimisation scenarios to use are associated with one or more circuits or types of circuits which it is believed they will be particularly effective for optimising. This may facilitate better selection of the optimisation scenario or scenarios to use when optimising a new circuit.

As will be appreciated by those skilled in the art, the above deals primarily with the derivation of the suite of optimisation scenarios to be used, i.e. with the “training phase” discussed above.

Once the suite of optimisation scenarios has been produced, it can be used as desired, and, e.g., in any suitable manner known in the art, to optimise electronic circuits when they are being designed (i.e. in the “operation phase” of the circuit design process). Thus, for example, when aspects or criteria of a new circuit design bearing some relationship to or corresponding to, etc., the aspect(s) or criteria for which the optimisation scenarios in the suite have been derived are to be optimised, the suite of optimisation scenarios can be used for that optimisation process.

In a particularly preferred embodiment, each of a plurality of the optimisation scenarios in the suite of optimisation scenarios is used to optimise the new circuit design, with one (a selected one) of the results of all the tested optimisation scenarios then being taken as the optimisation result to use for the new circuit (i.e. the optimised circuit design). In other words, plural optimisation scenarios are tried in turn for the circuit, and the, e.g., best result selected.

The Applicants have found that this arrangement will tend to provide a better optimisation result for a new, unknown circuit, as compared, e.g. to simply using a standard general purpose optimisation scenario, and without the need to derive specialised optimisation scenarios for each and every circuit that might be encountered. Furthermore, with a suite of optimisation scenarios derived in the manner of the present invention, in particular if they are evolved so as to provide relatively fast speeds of optimisation, it is feasible to test multiple optimisation scenarios in this way and to expect an improved optimisation result.

Thus, in a preferred embodiment, the present invention comprises steps of or means for carrying out optimisations of an aspect of the design of an electronic circuit to be optimised using two or more optimisation scenarios from the suite of plural optimisation scenarios, and selecting one of the optimisation results determined from the plural optimisations as the optimisation to use for the aspect of the circuit design.

In these arrangements, it would be possible, e.g., simply to use all the optimisation scenarios in the suite of optimisation scenarios for the optimisation process, and to, e.g., select the best one. Alternatively a more limited or selected set of optimisation scenarios could be tried, for example, based on the nature of or the type of circuit in question. This latter approach may be particularly useful where, e.g., the optimisation scenarios have been classified according to the type of circuit or circuits that they are more likely to be effective for.

The optimisation result that is used or selected after the multiple optimisation scenarios have been tried can be selected in any suitable and desired manner. For example, a scenario that provides a good result (and most preferable the best result), e.g. in terms of optimising the problem or aspects of the circuit in question, is preferably selected. It would also, e.g., be possible to take the best result achieved in a particular, preferably predetermined time period, even if, e.g. all the possible optimisation scenarios have not yet been tried.

Where, for example, multiple optimisation criteria (e.g. size, speed, power usage, etc.) are to be considered, then the optimisation result could be selected, e.g., based on a selected, e.g., predetermined, trade-off or ranking as between the different requirements. It would also be possible, e.g., to select between different such trade-offs, where, for example, the suite of optimisation scenarios provides plural acceptable optimisation results or options. This could facilitate further design exploration and optimisation of a given circuit or circuits.

Thus, the optimisation result that is selected is preferably based on a measure of the quality of the optimisation achieved using that optimisation scenario. Most preferably the optimisation providing the best quality optimisation result is selected. This optimisation quality can be measured in any suitable and desired manner.

In a particularly preferred embodiment, a, preferably predetermined, time limit is allowed for each optimisation scenario to perform its optimisation on the circuit, with, e.g., the optimisation result when the time limit is reached or the optimisation has finished, whichever is the sooner, being taken as the optimisation result for that scenario (and the system then moving to the next optimisation scenario to be tried). This helps to ensure that the process is sufficiently fast, even though multiple optimisation scenarios are being tried.

The time limit that is set (if any) could, e.g., be based on a trade-off between the time taken and the optimisation performance, and/or on the time that would be taken by a known, e.g., standard, general purpose script to achieve its best optimisation result for the circuit and optimisation criteria in question.

The optimisation scenarios could be used for, and applied to, the new circuit in exactly the same manner as when they were evolved. However, in a preferred embodiment, the optimisation scenarios may be and preferably are used and/or executed in a different way to the way in which they were used or executed when they were evolved (i.e. during the training phase), as this can be beneficial.

For example, a specialist optimisation scenario evolved for a particular target circuit will typically deliver the most highly optimised version of its target circuit at the end of the optimisation scenario's execution. However, for a circuit that is not the specific target circuit, the optimisation scenario may produce its best result at some intermediate point during the execution of the optimisation scenario.

Thus, in a particularly preferred embodiment, the quality of the optimisation is measured after each optimisation step of a scenario, and the best measured result taken and, if appropriate, used, as the result for that optimisation scenario (rather than, e.g. simply taking the end result of the optimisation scenario).

Similarly, it is preferred when using the optimisation scenarios to optimise a new circuit to allow iteration (repetition) of the optimisation scenario to take place. (As is known in the art, iteration of an optimisation scenario may be beneficial, but this may be unnecessary during the training phase (i.e. when the scenario is being derived in the first place), since in that phase a single scenario can be allowed to accommodate repetitions of sequences of optimisation steps within a single iteration of the optimisation scenario).

It is believed that such arrangements may be new and advantageous in their own right. Thus, according to a tenth aspect of the present invention, there is provided a method of optimising the design of an electronic circuit, comprising:

deriving an optimisation scenario for a selected, target electronic circuit;

using the derived optimisation scenario to optimise a circuit that is not the selected target circuit; and

executing the optimisation scenario in a different manner when optimising the circuit that is not the selected target circuit to the manner of execution of the optimisation scenario for the selected target circuit for which it has been derived.

According to an eleventh aspect of the present invention, there is provided an apparatus for optimising the design of an electronic circuit, comprising:

means for deriving an optimisation scenario for a selected, target electronic circuit;

means for using the derived optimisation scenario to optimise a circuit that is not the selected target circuit; and

means for executing the optimisation scenario in a different manner when optimising the circuit that is not the selected target circuit to the manner of execution of the optimisation scenario for the selected target circuit for which it has been derived.

The process of trying and assessing the multiple optimisation scenarios for a given circuit can be arranged as desired. For example, each optimisation scenario could be tried in turn, for example in a random order.

In one preferred embodiment, each optimisation scenario operates on the same initial description of the circuit to be optimised. In this case, each optimisation scenario will in effect run independently of the others and so all the optimisation scenarios can be, and, indeed, preferably are, executed in parallel, for example on plural processors operating in parallel.

In another preferred embodiment, the optimisation scenarios are executed sequentially (one after another), most preferably with each scenario in the sequence using the best result found by any of the previous scenarios as its starting point. In this case, the order of executing (trying) the optimisation scenarios can also be selected, if desired.

It would also be possible (e.g. if time permitted) to try both parallel and sequential execution of the optimisation scenarios along the lines discussed above.

It will be appreciated that when the optimisation scenarios are being used to optimise an aspect of a circuit's design, they will typically not be being used for the target circuit for which the optimisation scenario has been specifically evolved, but will be being used to optimise circuits for which they were not specifically designed.

It is believed that this may be new and advantageous in its own right. Thus, according to a twelfth aspect of the present invention, there is provided a method of optimising an electronic circuit to be designed, the method comprising:

using an optimisation scenario that has been derived for a target circuit to optimise a circuit that is different to the target circuit.

According to a thirteenth aspect of the present invention, there is provided an apparatus for optimising an electronic circuit to be designed, the apparatus comprising:

means for using an optimisation scenario that has been derived for a particular target circuit to optimise a circuit that is different to the target circuit.

Although the “training” and “operational” phases of the circuit design process have been described separately above, as will be appreciated by those skilled in the art, the present invention, as well as relating to and being directed to these individual processes, also relates to and covers the combined operation of deriving the optimisation scenarios and then using them to optimise electronic circuit designs.

Thus, according to a fourteenth aspect of the present invention, there is provided a method of optimising the design of an electronic circuit, comprising:

using an evolutionary algorithm or algorithms to evolve an optimisation scenario for each of a plurality of different electronic circuits;

including two or more of the optimisation scenarios evolved for the different circuits in a suite of optimisation scenarios for use to optimise electronic circuits during their design;

carrying out optimisations of an electronic circuit to be optimised using two or more optimisation scenarios from the suite of plural optimisation scenarios; and

selecting one of the optimisation results determined from the plural optimisations as the optimisation to use for the circuit.

According to a fifteenth aspect of the present invention, there is provided an apparatus for optimising the design of an electronic circuit, comprising:

means for using an evolutionary algorithm or algorithms to evolve an optimisation scenario for each of a plurality of different electronic circuits;

means for providing two or more of the optimisation scenarios evolved for the different circuits as a suite of optimisation scenarios for use to optimise electronic circuits during their design;

means for carrying out optimisations of an electronic circuit to be optimised using two or more optimisation scenarios from the suite of optimisation scenarios; and

means for selecting one of the optimisation results determined from the plural optimisations as the optimisation to use for the circuit.

According to a sixteenth aspect of the present invention, there is provided an electronic circuit that has been optimised by:

using an evolutionary algorithm or algorithms to evolve an optimisation scenario for each of a plurality of different electronic circuits;

including two or more of the optimisation scenarios evolved for the different circuits in a suite of optimisation scenarios for use to optimise electronic circuits during their design;

carrying out optimisations of an electronic circuit to be optimised using two or more optimisation scenarios from the suite of plural optimisation scenarios; and

selecting one of the optimisation results determined from the plural optimisations as the optimisation to use for the circuit.

As will be appreciated by those skilled in the art, these aspects and embodiments of the invention may and preferably do include any one or more or all of the preferred and optional features of the invention described herein, as appropriate.

The present invention also accordingly relates to the use of the techniques of the present invention to construct an electronic circuit and to an electronic circuit that has been constructed using the techniques of the present invention. The circuit itself can be constructed in any appropriate manner, for example by using known circuit design and construction techniques.

Thus, according to a seventeenth aspect of the present invention, there is provided a method of constructing an electronic circuit, comprising:

using an evolutionary algorithm or algorithms to evolve an optimisation scenario for each of a plurality of different electronic circuits;

including two or more of the optimisation scenarios evolved for the different circuits in a suite of optimisation scenarios for use to optimise electronic circuits during their design;

carrying out optimisations of an electronic circuit to be optimised using two or more optimisation scenarios from the suite of plural optimisation scenarios;

selecting one of the optimisation results determined from the plural optimisations as the optimisation to use for the circuit; and

designing and constructing an electronic circuit using the selected circuit optimisation.

According to an eighteenth aspect of the present invention, there is provided an apparatus for constructing an electronic circuit, comprising:

means for using an evolutionary algorithm or algorithms to evolve an optimisation scenario for each of a plurality of different electronic circuits;

means for providing two or more of the optimisation scenarios evolved for the different circuits as a suite of optimisation scenarios for use to optimise electronic circuits during their design;

means for carrying out optimisations of an electronic circuit to be optimised using two or more optimisation scenarios from the suite of optimisation scenarios;

means for selecting one of the optimisation results determined from the plural optimisations as the optimisation to use for the circuit; and

means for designing and constructing an electronic circuit using the selected circuit optimisation.

According to a nineteenth aspect of the present invention, there is provided an electronic circuit that has been constructed by:

using an evolutionary algorithm or algorithms to evolve an optimisation scenario for each of a plurality of different electronic circuits;

including two or more of the optimisation scenarios evolved for the different circuits in a suite of optimisation scenarios for use to optimise electronic circuits during their design;

carrying out optimisations of an electronic circuit to be optimised using two or more optimisation scenarios from the suite of plural optimisation scenarios; and

selecting one of the optimisation results determined from the plural optimisations as the optimisation to use for the circuit; and

designing and constructing an electronic circuit using the selected circuit optimisation.

As will be appreciated by those skilled in the art, these aspects and embodiments of the invention may and preferably do include any one or more or all of the preferred and optional features of the invention described herein, as appropriate.

As will also be appreciated by those skilled in the art, the training and operational phases may be conducted one after another, and using the same, e.g. hardware and/or software, or equally could be carried individually and in different locations and/or by different individuals and/or organisations. For example, the optimisation scenarios could be derived by an electronic design automation tool vendor, with the circuit optimisations (operational phase) then being carried out by customers or end-users of the EDA tool. Equally, individuals or organisations could derive their own suites of optimisation scenarios and/or pool suites of optimisation scenarios, and then use them to optimise circuit design.

It will also be appreciated that the evolution of optimisation scenarios and their inclusion in the suite of optimisation scenarios to use can be, and preferably is, an ongoing process. Thus, the training phase need not cease once the operational phase has begun to be employed. For example, additional beneficial optimisation scenarios that are identified and derived by ongoing training phases could be added to the suite of optimisation scenarios to be used. Equally, new circuits to evolve optimisation scenarios for, for inclusion in the suite of optimisation scenarios to be used, could be identified from weaknesses or poor optimisation performance identified during use of the suite of optimisation scenarios to optimise the design of circuits (i.e. during the operational phase).

The present invention may be used to derive and use optimisation scenarios for any suitable electronic design automation tool, such as for such tools and techniques already known in the art. The present invention is particularly, although not exclusively, suited to use with and for optimisation scenarios (scripts) of the Berkeley SIS system. In applying the present invention to the Berkeley SIS system, there is no need to modify the SIS software itself.

The present invention can be applied to the optimisation of any and all types of circuit design, such as general purpose processors, digital signal processors, application specific signal processors, field programmable devices, application specific integrated circuits, physically optimised integrated circuits and system on chip integrated circuits. It is particularly applicable to digital electronics, but could be used for analogue circuits as well, if desired. The present invention also accordingly extends to an electronic circuit that has been designed using any of the methods and/or apparatus of the present invention, and to apparatus for or a method of constructing an electronic circuit, including steps of or means for constructing the circuit itself, using any of the methods and/or apparatus of the present invention.

As will be appreciated by those skilled in the art, all of the aspects of the invention described herein can and preferably do include using one or more or all of the optional and preferred features of the invention described herein, as appropriate. Thus, for example, where an optimisation scenario is to be derived for a circuit, it is preferably derived using an evolutionary process.

The methods in accordance with the present invention may be implemented at least partially using software e.g. computer programs. It will thus be seen that when viewed from further aspects the present invention provides computer software specifically adapted to carry out a method or the methods herein described when installed on data processing means, a computer program element comprising computer software code portions for performing a method or the methods herein described when the program element is run on data processing means, and a computer program comprising code means adapted to perform all the steps of a method or of the methods herein described when the program is run on a data-processing system. The invention also extends to a computer software carrier comprising such software which when used to operate an electronics design or construction system comprising data processing means causes in conjunction with said data processing means said system to carry out the steps of the method of the present invention. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the method of the invention need be carried out by computer software and thus from a further broad aspect the present invention provides computer software and such software installed on a computer software carrier for carrying out at least one of the steps of the methods set out herein.

The present invention may accordingly suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or radio. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

A number of preferred embodiments of the present invention will now be described by way of example only, and with reference to the accompanying drawings, in which:

FIG. 1 shows schematically a process for the design of digital electronics;

FIG. 2 shows schematically an exemplary evolutionary algorithm process;

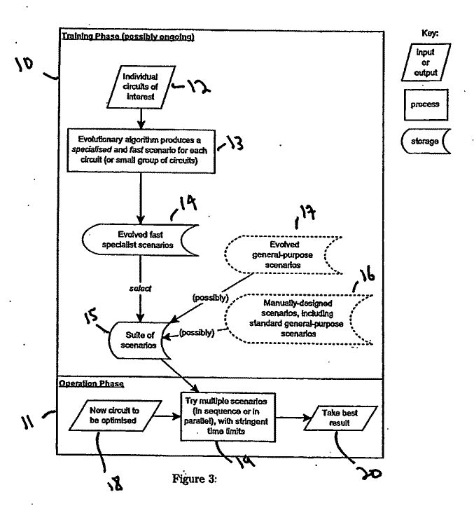

FIG. 3 shows schematically an embodiment of the present invention;

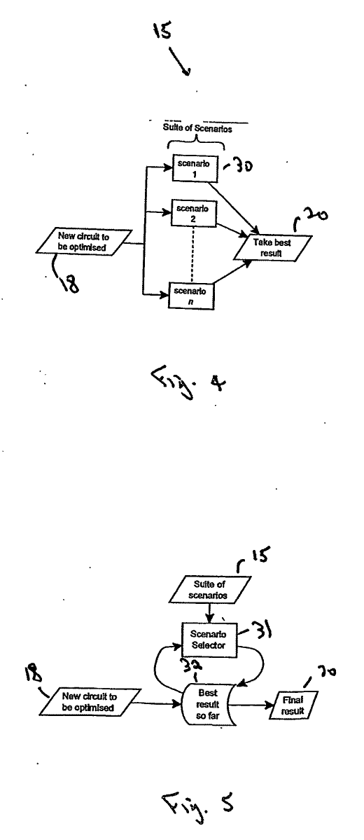

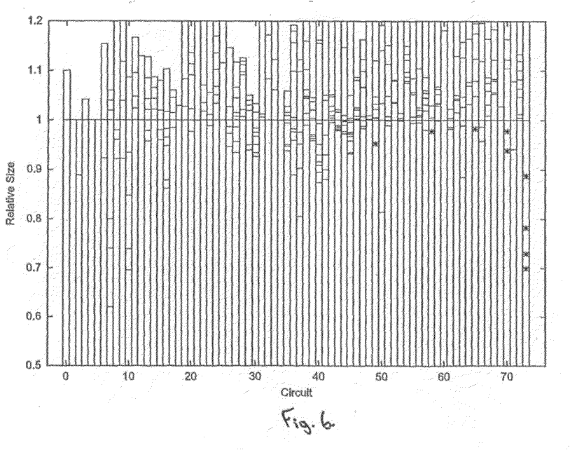

FIGS. 4 and 5 show schematically the use of optimisation scenarios to optimise a circuit in an embodiment of the present invention; and

FIG. 6 shows the optimisation performance of an embodiment of the present invention.

A preferred embodiment of the present invention will now be described with reference to the Berkeley SIS electronics design automation system. The SIS system is described, for example, in: E. M. Sentovich, K. J. Singh, L. Lavagno, C. Moon, R. Murgai, A. Saldanha, H. Savoj, P. R. Stephan, R. K. Brayton, and A. Sangiovanni-Vincentelli, SIS: A system for sequential circuit synthesis. Technical Report UCB/ERL M92/41, University of California, Berkeley, 1992; and E. M. Santovich, Sequential Circuit Synthesis at the Gate Level, PhD thesis, Dept. Electrical Engineering and Computer Sciences, University of California, Berkeley, 1992.

(It should be noted, however, that although the present embodiment is described with reference to the SIS system, the present invention is, as will be appreciated by those skilled in the art, not exclusive to the SIS system, but can be applied to and used with other techniques for electronic design automation as well).

As is known in the art, SIS software is freely available and widely used both in practice and in the literature. It is therefore a well-known and well-understood electronics design automation tool. SIS can perform technology-independent optimisation, technology mapping and technology-dependent optimisation.

SIS optimisation scenarios are given as a “script” supplied as a text file to the SIS software. Much effort has gone into deriving good general-purpose scripts for SIS systems, through theory and manual experimentation, and a selection of scripts is included in the SIS software distribution. SIS provides many different optimisation commands that may appear in its optimisation scripts, and many of these commands take numerical parameters and option flags that fine-tune their behaviour.

Three of the most widely used SIS scripts are script.rugged, script.algebraic, and script.boolean. These scripts are set out below:

script.rugged:

```
# Initial pre-processing: try both with this and without this command:
full_simplify
REPEAT until no further improvement possible, keeping best result:
{
    sweep
    eliminate −1
    simplify −m nocomp
    eliminate −1
    sweep
    eliminate 5
    simplify −m nocomp
    resub − a
    fx
    resub −a
    sweep
    eliminate −1
    sweep
    full_simplify −m nocomp
}
```

script.algebraic:

```
# Initial pre-processing: try both with and without this command:
full_simplify
REPEAT until no further improvement possible, keeping best result:
{
    sweep
    eliminate 5
    simplify −m nocomp −d
    resub −a
    gkx −abt 30
    resub −a
    sweep
    gcx −bt 30
    resub −a
    sweep
    gkx −abt 10
    resub −a
    sweep
    gcx −bt 10
    resub −a
    sweep
    gkx −ab
    resub −a
    sweep
    gcx −b
    resub −a
    sweep
    eliminate 0
    decomp −g *
}
```

script.boolean:

```
#Initial pre-processing: try both with and without this command:
full_simplify
REPEAT until no further improvement possible, keeping best result:
{
    sweep
    eliminate −1
    simplify
    eliminate −1
    sweep
    eliminate 5
    simplify
    resub −a
    gkx −abt 30
    resub −a
    sweep
    gcx −bt 30
    resub −a
    sweep
    gkx −abt 10
    resub −a
    sweep
    gcx −bt 10
    resub −a
    sweep
    gkx −ab
    resub −a
    sweep
    gcx −b
    resub −a
    sweep
    eliminate 0
    decomp −g *
    eliminate −1
    sweep
}
```

A common optimisation strategy using SIS scripts is to try script.rugged, and if this fails to produce a result in the time available, to use script.algebraic.

In the present embodiment, the standard SIS 1.3 software was used in an unaltered state, save for very minor additions to allow execution timings to be measured more accurately, and to allow optimisation results to be logged for easy access by the evolutionary algorithm software (which is completely separate).

FIG. 3 shows schematically a system for the derivation of optimisation scenarios for an electronic circuit design, and then the use of those scenarios to optimise electronic circuits to be designed, that is in accordance with the present invention.

As shown in FIG. 3, and as discussed above, the system of the present embodiment can be considered to divide into two distinct parts or phases, a first, training phase 10 in which optimisation scenarios for selected electronic circuits are derived using an evolutionary algorithm, and then a second, operation phase 11, in which the derived optimisation scenarios are used to optimise new electronic circuits to be designed.

As shown in FIG. 3, the training phase 10 in which optimisation scenarios are derived comprises a number of steps.

Firstly, selected individual circuits or small groups of circuits of interest are provided as inputs to the optimisation scenario derivation process (step 12).

An evolutionary algorithm is then used to produce a specialised and relatively fast optimisation scenario for each of the input circuits and groups of circuits (step 13). This provides a set of evolved fast optimisation scenarios that have been specifically derived for the input individual circuits or groups of circuits (step 14).

One or more of the evolved specialist optimisation scenarios are then selected to form a suite (set) of optimisation scenarios (step 15), which will then be used for optimising new circuits to be designed.

The selection of which optimisation scenarios to include in the suite of optimisation scenarios 15 to be used can be made as desired. For example, it could be based on an estimate of the number of circuits in addition to the target circuit (i.e. the auxiliary circuits) that a given optimisation scenario will provide an improved optimisation performance for, and/or how well that optimisation scenario and the circuits that it provides improved optimisation performance for complements the other optimisation scenarios present in the suite of optimisation scenarios.

As shown in FIG. 3, it would also be possible to augment the suite of evolved optimisation scenarios 15 with, for example, optimisation scenarios produced by other methods, such as, for example, manually design scenarios, including standard general purpose scenarios 16, or an evolved more general purpose scenario 17.

The evolutionary algorithm used in step 13 to evolve the optimisation scenario for each circuit (or group of circuits) can take any suitable form. FIG. 2 shows schematically the basic operation of evolutionary (genetic) algorithms. Evolutionary algorithms that operate in this manner are suitable for use in the present invention.

As shown in FIG. 2, the evolutionary algorithm basically operates by taking an initial set of candidate solutions (i.e., in this case optimisation scenarios) (step 21), and then evaluating the performance of the candidate solutions at the desired task (commonly referred to as measuring the “fitness” of the candidate solution) (step 22). The candidate solutions found to have the poorest performance under this evaluation are then discarded (step 23), and the candidates found to perform better are selected to act as “parents” for use to evolve new, hopefully improved, candidate solutions (step 24).

The selected “parent” candidate solutions are then combined and/or varied in some way (such as at random) to form some new candidate solutions (commonly referred to as “offspring” candidates) (step 25), which newly evolved candidate solutions are then evaluated themselves and the process is repeated until some defined end point is reached (step 26).

In the present embodiment, the evolutionary algorithm used was a genetic algorithm with no extraordinary features. Such genetic algorithms are described, for example, in: J. H. Holland, Adaption in Natural Artificial Systems, Ann Arbor, University of Michigan Press, 1975, and D. E. Goldberg, Genetic Algorithms in Search, Optimisation and Machine Learning, Addison Wesley, 1989.

The genetic algorithm used, used linear rank selection with truncation and elitism, acting on a population of 30. Each evolutionary run commenced with a different initial population of optimisation scenarios, with each optimisation scenario being randomly generated and exactly three commands long. (It would, of course, also be possible to seed an evolutionary run from a pre-existing result (whether, e.g. hand-designed, or evolved previously), if desired.

To evaluate the fitness of the optimisation scenarios and place them into order, the optimisation scenarios were compared firstly according to the optimisation result (i.e. the optimisation quality metric) provided by each optimisation scenario. In the event that the optimisation quality of the scenarios was equal, then the candidate scenarios were ranked according to the time taken for the optimisation scenarios (scripts) to terminate (favouring the faster scenario). If there was still a tie, then the shortest candidate scenario was ranked highest. (As is known in the art, this method of dealing with multiple criteria of fitness having a fixed priority is often termed lexicographical or dictionary ordering.)

The candidate optimisation scenarios were typically evolved over a few hundred generations to provide the final output evolved optimisation scenario. The “genetic” variations that were allowed in evolving the candidate optimisation scenarios (step 25 in FIG. 2) in this embodiment were as follows:

Mutation—New Command: A command of the scenario is replaced with a new random command, and any parameters are also chosen at random.
Mutation—New Command Variant: The symbolic flags defining a particular version of a command are randomised. If the number of numerical parameters associated with the command is not changed by this, and the valid ranges of those parameters are also unchanged, then the numerical parameters are left unchanged. Otherwise, any numerical parameters associated with the new command variant are generated at random.
Mutation—Parameters: One of the numerical parameters of a command is adjusted by the breeder genetic algorithm (BGA) mutation method (see H. Mühlenbein and D. Schierkamp-Voosen, The Science of Breeding and its Application to the Breeder Genetic Algorithm BGA, Evolutionary Computation, 1(4):335-360, 1994).
Homologous crossover: Standard two-point crossover, always keeping the parameters unseparated from the associated commands.
Nonhomologous crossover: As above, but the segment between the crossover points is randomly translocated.
Insert: Inserts one new random command at a random position, randomly generating any parameters.
Delete: Removes one randomly chosen command.
Block insert: Chooses a consecutive sequence of commands at a random location and of random length in one parent scenario, and inserts it at a random position in the second parent (increasing the scenario length) to generate an offspring.
Block delete: Chooses a consecutive sequence of commands at a random location and of random length, and removes it.

These “genetic” variation operators were configured to work on a direct numerical representation of the optimisation scenarios using integers only. The probabilities chosen for the different genetic variation operators were derived through experimentation. Other techniques, would, of course, be possible. The probabilities of use of the operators that change the length of an optimisation scenario were balanced such that there was no inbuilt tendency for optimisation scenarios to grow or shrink in the absence of selection. The numerical representation used was chosen so as to guarantee that each SIS command would have a valid set of parameters, i.e. such that invalid optimisation scenarios were not possible during the evolution.

The above genetic algorithm was used to evolve optimisation scenarios for selected circuits of interest (target circuits), using the selection (fitness) criteria discussed above. During the evolutionary runs, it was found that even after the optimisation quality stopped improving, there was usually a final phase in which the speed of optimisation was improved.

Turning now to the operation phase 11 shown in FIG. 3, namely the use of the suite of selected optimisation scenarios to optimise new circuits, as shown in FIG. 3, this process has three steps. Firstly, a new circuit to be optimised is input at step 18. A plurality of optimisation scenarios from the suite of optimisation scenarios 15 is then used (e.g. in sequence or in parallel) to try to optimise the new circuit (step 19), and the best optimisation result is taken as the optimisation for the circuit (step 20). In other words, a plurality of the selected specialist optimisation scenarios in the suite is tried until a good optimisation result is achieved.

In this embodiment, all the optimisation scenarios in the suite of optimisation scenarios 15 are tried for each and every new circuit to be optimised. Alternatively, some form of selection of the optimisation scenarios to try could be made, for example based on the known performance of the optimisation scenarios for a particular type or types of circuit.

As shown in FIG. 3, a time limit is set for each optimisation scenario that is tried, with the best result being taken once the time limit has been reached. This helps to ensure the overall efficiency of the process (but is not essential).

In the present embodiment, when the optimisation scenarios are being used to optimise a new circuit in the operation phase, the scenarios are executed in a different way to the way that they were executed during the training phase. This is to allow for the fact that during the training phase, the evolutionary process is directed towards developing an optimisation scenario with the sole objective of optimising its specialist target circuit. However, in the operation phase, the optimisation scenarios will be used to optimise different circuits to their target circuit, i.e. a purpose for which they were not designed. It can therefore be beneficial to use the optimisation scenarios in a slightly different manner in the operation phase.

To take account of this, rather than simply evaluating the result of the optimisation scenario at the very end of the scenario's execution, in the operation phase, the quality of the optimisation is measured after each step in the optimisation scenario (e.g. by including a command to output the appropriate quality metric (such as the SIS print_stats-f command discussed below) after each step), and the best result taken. This arrangement can be referred to as “single-stepping”, since the results of the optimisation scenario are assessed after each single step in the scenario, rather than simply at its end.

It would also be possible, for example, to allow iteration (i.e. repeated execution) of the optimisation scenarios during the operation phase, for example, starting each time with the best results so far. There is no need to do this during the training phase, because a single optimisation scenario can grow in length to accommodate repetitions within a single iteration. However, when an optimisation scenario evolved specifically for a given target circuit is applied to other circuits during the operation phase, iteration can be beneficial.

The way that the multiple optimisation scenarios are tried on each new circuit to be optimised in step 19 of the operation phase 11 can be selected as desired. FIGS. 4 and 5 illustrate two possible alternative such arrangements.

In the arrangement shown in FIG. 4, each optimisation scenario 30 is applied to a new circuit 18 to be optimised in parallel, with each scenario 30 beginning work on the same initial description of the circuit to be optimised. The best result 20 is then taken. This arrangement could, for example, be executed on plural processors operating in parallel, so as to speed its execution.

FIG. 5 shows an alternative arrangement in which the optimisation scenarios 15 are applied sequentially to a new circuit 18 to be optimised with each new optimisation scenario beginning work on the best results found by any of the previously tried optimisation scenarios. Thus an optimisation scenario to try on the circuit 18 is selected (step 31), and then applied to the best result found so far (step 32), and then a new optimisation scenario selected and used, and so on, until the final result 20 is selected. In this arrangement, it would be possible, for example, to select the order in which the optimisation scenarios are tried, as that may again further enhance the optimisation process.

The performance of the circuit optimisation system of the present embodiment was compared with the performance of the SIS system using the standard optimisation scenarios (scripts) supplied with the SIS system. For this performance evaluation, seventy-four test circuits were taken from the widely-used MCNC '91 benchmark set of circuits (see S. Yang, Logic synthesis and optimisation benchmarks user guide version 3.0, Technical report, Microelectronics Center of North Carolina, P.O. Box 12889, Research Triangle Park, N.C. 27709, 1991; and N. Whitaker, Status report on EDA benchmarks, Technical report STEED/T1/01/4, MINT Group, Dept. Computer Science, Univ. Manchester, UK.). These circuits are set out in Table 1 below.

TABLE 1
Test set of circuits from the MCNC'91 benchmark suite.

| | Name | Type | Inputs | Outputs |
|---|---|---|---|---|
| 0 | majority | voter | 5 | 1 |
| 1 | b1 | logic | 3 | 4 |
| 2 | C17 | logic | 5 | 2 |
| 3 | cm82a | logic | 5 | 3 |
| 4 | parity | logic | 16 | 1 |
| 5 | tcon | logic | 17 | 16 |
| 6 | cm151a | logic | 12 | 2 |
| 7 | cmb | logic | 16 | 4 |
| 8 | cm150a | logic | 21 | 1 |
| 9 | mux | mux | 21 | 1 |
| 10 | cm85a | logic | 11 | 3 |
| 11 | cm163a | logic | 16 | 5 |
| 12 | cm138a | logic | 6 | 8 |
| 13 | x2 | logic | 10 | 7 |
| 14 | i1 | logic | 25 | 16 |
| 15 | pm1 | logic | 16 | 13 |
| 16 | cu | logic | 14 | 11 |
| 17 | pcle | logic | 19 | 9 |
| 18 | cm42a | logic | 4 | 10 |
| 19 | z4ml | 2-bit add | 7 | 4 |
| 20 | cm162a | logic | 14 | 5 |
| 21 | unreg | logic | 36 | 16 |
| 22 | cc | logic | 21 | 20 |
| 23 | pcler8 | logic | 27 | 17 |
| 24 | cordic | logic | 23 | 2 |
| 25 | decod | decoder | 5 | 16 |
| 26 | sct | logic | 19 | 15 |
| 27 | c8 | logic | 28 | 18 |
| 28 | count | counter | 35 | 16 |
| 29 | 1al | logic | 26 | 19 |
| 30 | b9 | logic | 41 | 21 |
| 31 | cht | logic | 47 | 36 |
| 32 | my_adder | adder | 33 | 17 |
| 33 | comp | logic | 32 | 3 |
| 34 | i5 | logic | 133 | 66 |
| 35 | example2 | logic | 85 | 66 |
| 36 | ttt2 | logic | 24 | 21 |
| 37 | i3 | logic | 132 | 6 |
| 38 | x1 | logic | 51 | 35 |
| 39 | apex7 | logic | 49 | 37 |
| 40 | term1 | logic | 34 | 10 |
| 41 | frg1 | logic | 28 | 3 |
| 42 | i2 | logic | 201 | 1 |
| 43 | x4 | logic | 94 | 71 |
| 44 | C880 | ALU and control | 60 | 26 |
| 45 | x3 | logic | 135 | 99 |
| 46 | apex6 | logic | 135 | 99 |
| 47 | rot | logic | 135 | 107 |
| 48 | i6 | logic | 138 | 67 |
| 49 | C499 | error correcting | 41 | 32 |
| 50 | 9symml | count ones | 9 | 1 |
| 51 | frg2 | logic | 143 | 139 |
| 52 | vda | logic | 17 | 39 |
| 53 | i7 | logic | 199 | 67 |
| 54 | pair | logic | 173 | 137 |
| 55 | C2670 | ALU and control | 233 | 140 |
| 56 | i9 | logic | 88 | 63 |
| 57 | C5315 | ALU and selector | 178 | 123 |
| 58 | C6288 | 16-bit multiplier | 32 | 32 |
| 59 | C3540 | ALU and control | 50 | 22 |
| 60 | C7552 | ALU and control | 207 | 108 |
| 61 | C1355 | error correcting | 41 | 32 |
| 62 | C1908 | error correcting | 33 | 25 |
| 63 | C432 | priority decoder | 36 | 7 |
| 64 | k2 | logic | 45 | 45 |
| 65 | alu2 | ALU | 10 | 6 |
| 66 | alu4 | ALU | 14 | 8 |
| 67 | des | data encryption | 256 | 245 |
| 68 | dalu | dedicated ALU | 75 | 16 |
| 69 | t481 | logic | 16 | 1 |
| 70 | i10 | logic | 257 | 224 |
| 71 | i4 | logic | 192 | 6 |
| 72 | i8 | logic | 133 | 81 |
| 73 | too_large | logic | 38 | 3 |

To measure the performance of the standard SIS scenarios, each of script.rugged, script.algebraic, script.boolean and full_simplify alone, were run on each circuit. The computer used was a 2.2 GHz Intel Pentium PC with 512 Mbytes memory, running Linux.

Each script was tried both with and without the initial full_simplify command separately. Each combination was allowed up to 24 hours of processor time on each circuit, or 36 hours of real (wall clock) time, whichever was the shortest. If no improvement was made over the initial circuit, then a script's result was always taken to be that initial circuit. The circuits were input to SIS in the form in which they are included in the SIS software distribution. The “repeat until no further improvement possible” script criterion was interpreted such that the script would be terminated after the first iteration that did not give an improvement.

For each circuit c, the target for the method of the present embodiment to beat was taken as the best result seen from these general purpose SIS standard scripts, and was denoted as gps_{c}.

It should be noted here that although some scripts are stochastic and can produce slightly different results when repeated under conditions identical but for the computer's random number generator, the results of the present evaluations were found to be sufficiently repeatable without taking this into account.

The scenarios were used for technology independent optimisation. The optimisation criterion chosen was to minimise the number of literals in factored form, as reported by the SIS command print_stats-f. As discussed above, this optimisation criterion provides a measure of the overall complexity of the logic in the directed acyclic graph of Boolean functions that represents the circuit. In this assessment, no account was taken of other optimisation criteria such as delay (longest path) from circuit inputs to outputs, although that could be done, if desired.

Similarly, for these examples, the quality metric used during the evolution of new specialist optimisation scenarios (scripts), i.e. during the training phase 10, was the count of the literals in the factored form when the optimisation scenario terminates. In other words, the output of the SIS command print_stats-f (which causes the number of literals in factored form to be counted) was used as the measure of the optimisation quality provided by the scenario in question. This figure for the evolved optimisation scenarios, when applied to a new circuit to be optimised in the operation phase, was then compared with the smallest corresponding figure produced by any of the general purpose standard SIS scripts run as described above.

For the evolutionary process, the evolved optimisation scenarios and the evolutionary runs were performed on a 1.6 GHz laptop PC with 256 Mbytes of memory. The maximum amount of time allowed for an optimisation scenario to terminate during evolution varied depending on what target circuit was being optimised, but was never more than 600 seconds. The evolutionary algorithm discussed above was used, and thus within this time limit, there was also a selection for optimisation scenarios to be as fast as possible without sacrificing quality. It should be noted here that in the following examples, where an evolved optimisation scenario out performs the more general purpose standard scripts on some “auxiliary” (i.e. non-target) circuits, this never takes more than 550 seconds on the 1.6 GHz PC, and usually much less time.

The first target circuit for the exemplary training phase for which an evaluation comparison was made was circuit C6288 (circuit 58 in Table 1 above). This circuit was chosen as an example because it has already been remarked that it is troublesome both for SIS systems and for alternative optimisation techniques based on binary decision diagrams.

The method of the present embodiment evolved the following fast specialist optimisation script A to optimise the circuit C6288:

Script A:

eliminate −1 10000 −1
eliminate −1 2989 47
fx
eliminate −1 841 −1
fx
eliminate −1 3631 47
fx
eliminate −1 1077 75
sweep
fx
simplify −m dcsimp
decomp −g
decomp −g
resub *
eliminate −1 9995 0
simplify −m nocomp −f disj_sup
simplify −i 3 −m dcsimp
eliminate −1 9990 −1
simplify −i 3 −m dcsimp
eliminate −1 9366 0.

Script A was also found to perform well on (i.e. optimise well) twelve of the other 73 test circuits in the test set. These circuits accordingly are amongst the “auxiliary circuits” for Script A.

Table 2 below shows these circuits for which evolved Script A performs better than any of the three standard SIS scripts. In Table 2, gps_{c} is the smallest number of literals in factored form from any of the three general purpose standard SIS scripts, and t(gps_{c}) is the processor time in seconds taken by the script. evo^{A}_{c} and t(evo^{A}_{c}) give the corresponding performance of Script A. The time taken by the slowest of the standard SIS scripts is also shown.

For this analysis, Script A was executed on the same 2.2 GHz reference PC as were the standard scripts, to allow a direct timing comparison.

TABLE 2

| | | General-Purpose Standard | | | Evolved | |
|---|---|---|---|---|---|---|
| | | BEST | | SLOWEST | | t |
| Circuit | | gps_{c} | t (gps_{c}) | t (slowest) | evo^{A}_{c} | (evo^{A}_{c}) |
| 6 | cm151a | 26 | 0.05 | 0.06 | 24 | 0.02 |
| 15 | pm1 | 50 | 0.09 | 0.11 | 49 | 0.04 |
| 26 | sct | 75 | 0.19 | 0.20 | 71 | 0.08 |
| 27 | c8 | 137 | 0.23 | 0.27 | 131 | 0.11 |
| 29 | la1 | 100 | 0.20 | 0.24 | 94 | 0.09 |
| 30 | b9 | 122 | 0.17 | 0.26 | 119 | 0.12 |
| 39 | apex7 | 243 | 0.52 | 0.81 | 233 | 0.22 |
| 40 | term1 | 142 | 0.77 | 0.98 | 141 | 0.42 |
| 42 | i2 | 213 | 0.52 | 2.76 | 212 | 8.33 |
| 44 | C880 | 408 | 3.13 | 3.14 | 399 | 5.93 |
| 55 | C2670 | 712 | 14.16 | 14.16 | 709 | 146.8 |
| 58 | C6288 | 3295 | 18.26 | 21.38 | 3222 | 18.35 |
| 71 | i4 | 204 | 0.26 | 86400 timeout | 192 | 0.33 |

The present embodiment was also used to evolve a fast specialist optimisation scenario for circuit 73 in Table 1, too_large. Script B shown below was evolved to optimise this circuit:

Script B:

collapse
full_simplify −o 1 −m snocomp −1
fx −oz
full_simplify −d −o 0 −m dscimp
xl_partition −n 18 −M 1 −t
full_simplify −o 0 −m dcsimp
eliminate −1 9395 0
full_simplify −d −o 0 −m dcsimp
full_simplify −o 0 −m dcsimp −1
fx −ol
fx −lz
full_simplify −o 0 −m dcsimp −1
decomp −g
eliminate −1 951 3
eliminate −1 789 19
full_simplify −o 1 −m dscimp
fx −1
full_simplify −d −o 0 −m dcsimp
full_simplify −o 1 −m dcsimp
eliminate −1 9365 8
full_simplify −o 0 −m snocomp
eliminate −1 4988 −1
eliminate −1 1934 10
full_simplify −o 0 −m dcsimp
fx −1
full_simplify −o 0 −m snocomp
eliminate −1 9371 7
fx −olz
fx
eliminate −1 9688 8
full_simplify −d −o 1 −m snocomp
fx −z
eliminate −1 9963 −1
full_simplify −o 0 −m dcsimp
decomp −q
eliminate −1 2032 6
simplify −i 20:1 −m nocomp
fx −olz
fx −ol
phase −g
eliminate −1 9838 −1

It should be noted here that in this Script B, any redundant commands have been pruned away. In other words, no single command can further be removed without degrading the performance of the script when optimising the circuit too_large.

Table 3 below shows the performance of Script B for optimising its target circuit 73, and its set of auxiliary circuits (from the 74 circuits in Table 1, on which it was tested).

TABLE 3

| | Improvement at | Best improvement |
|---|---|---|
| Circuit | script termination (%) | if single-stepped (%) |
| 2 | 11.1 | 11.1 |
| 6 | 3.8 | 7.7 |
| 7 | 26.0 | 38.0 |
| 8 | — | 7.8 |
| 9 | — | 7.8 |
| 10 | 30.4 | 30.4 |
| 13 | 4.3 | 4.3 |
| 15 | — | 4.0 |
| 16 | 12.1 | 12.1 |
| 23 | — | 1.1 |
| 26 | — | 1.3 |
| 27 | 4.4 | 4.4 |
| 30 | 1.6 | 1.6 |
| 35 | 5.3 | 5.3 |
| 36 | 4.1 | 4.1 |
| 37 | — | 19.5 |
| 40 | 9.2 | 9.2 |
| 41 | 5.0 | 10.0 |
| 45 | — | 2.5 |
| 50 | 15.3 | 18.6 |
| 51 | — | 1.1 |
| 71 | 2.0 | 5.9 |
| 73 | 30.1 | 30.1 |

Table 3 shows the percentage improvement over the best of the three general purpose standard SIS scripts in each case (where that improvement is positive). The right-hand column in Table 3 shows the performance improvement for single-stepped assessment of the Script B for optimising the circuit in question (i.e. where the quality of optimisation is measured after each step in the optimisation scenario and the best result taken, rather than simply taking the result at the end of the scenario, as discussed above).

It can be seen that Script B provides improved optimisation performance, particularly if “single-stepped” in the operation phase, for a number of circuits.

A further performance evaluation was carried out using a suite of ten evolved specialist optimisation scenarios. The results of the analysis of the performance of this suite of optimisation scenarios is shown in FIG. 6.

The asterisks in FIG. 6 show the circuits and conditions for which the ten optimisation scenarios in the suite were actually evolved. These evolved optimisation scenarios include Scripts A and B discussed above.

FIG. 6 shows the performance of this suite of optimisation scenarios across the 74 sample circuits of Table 1, relative to the best of the general purpose SIS standard scripts for each circuit. In FIG. 6, a bar is drawn for each script tested on each circuit (some overlap identically). In FIG. 6, a relative size of “1” represents the performance of the best general purpose standard SIS script for the circuit in question. Thus, a relative size of 0.9 for an evolved optimisation scenario, for example, means that the performance of the evolved optimisation scenario was 10% better than the best standard script for that circuit. (The worst results go off the scale at the top of FIG. 6.)

It can be seen from FIG. 6 that even with a suite of only ten evolved optimisation scenarios, the optimisation performance achievable using that suite of optimisation scenarios is already better than the best of the general-purpose standard SIS scripts for over half the circuits, sometimes dramatically so.

The results shown in FIG. 6 were derived using a single-stepping evaluation process for the optimisation scenarios in the operation phase, as discussed above. Iteration and sequential application of scenarios were not used, although they could be if desired and may lead to improved results.

It can also be seen from FIG. 6 that the performance using the suite of evolved optimisation scenarios alone may be inferior for some circuits. However, this could be avoided by, for example, adding the standard, general-purpose SIS scripts to the suite of optimisation scenarios (e.g. with appropriate time allowances for their operation). This would cap the performance of the suite of optimisation scenarios at a relative size of “1” (as shown by the solid horizontal line at relative size=1 in FIG. 6). Performance could also be improved by adding further or alternative evolved optimisation scenarios to the suite.

Although the above examples have been discussed with reference to a single technology-independent optimisation criterion only, it would be possible for the evolved optimisation scenarios in accordance with the present invention to span optimisation activities that are normally considered separately.

For example, instead of performing technology-independent optimisation in isolation, the subsequent technology mapping could also be performed or taken into account, with the quality metric for the optimisation then being taken as the total mapped area, rather than, e.g., the literals in the factored form of the network before mapping. The optimisation scenario would then take account of the characteristics of the mapping algorithm and the technology library, as well as of the technology-independent optimisation.

An example fabrication technology is described by the CMOS standard-cell library stdcell2_{—}2.genlib mapping algorithm distributed with the SIS software. One could, for example, predefine that the mapping is to be performed with the SIS commands map-m 0-AF; phase-g, recommended for a minimum area circuit that respects the load limits given in the technology library. This could be allowed for in the optimisation scenario evolution by appending these commands to every optimisation scenario during evolution, and taking the resulting mapped area as the quality of the optimisation.

An optimisation scenario evolved in this way to optimise the circuit my_adder, with mapping to library stdcell2_{—}2 is shown below:

simplify −m dscimp
map −f 3 −B 0 −1
decomp −q
tech_decomp −a 2 −o 2
xl_partition −t
simplify
simplify −m dcsimp
fx −z
# Predetermined final mapping:
map −m 0 −AF; phase −g

In this script, the second command of the evolved script performs a preliminary mapping to the technology library. The subsequent commands do destroy the perfect correspondence between the components in the technology library and nodes in the directed acyclic graph representing the circuit. However, notwithstanding this, if the preliminary mapping command is removed, then the area after the predefined final mapping was found to increase. The script therefore appears to be taking greater account of the mapping process than if it were simply to optimise the literals in factored form before the final mapping.

Optimisation scenarios that take account of additional or later optimisation criteria, such as this scenario, could also be included in the suite of optimisation scenarios to use, if desired, thereby potentially giving a more “technology aware” optimisation.

Once a circuit has been optimised, it can then be constructed, e.g. using known techniques, as is known in the art.

It can be seen from the above that the present invention, in its preferred embodiments at least, provides a system for the optimisation of electronic circuits to be designed that provides improvements over known, existing optimisation techniques. It provides an improved tool and techniques for use in designing and constructing electronic circuits.

This is achieved, in particular, by evolving a suite of specialist optimisation scenarios, which scenarios are then used in turn to optimise a new circuit to be optimised, with the best result being taken as the final optimisation.

The Applicants have in particular appreciated that if one evolves scripts that operate quickly enough to allow sufficient evolution, then it is usually relatively easy to produce specialist optimisation scenarios that do better for their target circuits than any of the known, standard general purpose scripts. Furthermore, the superior evolved optimisation scenarios may in fact take less processor time to complete their optimisations than the general known general-purpose standard scripts.

Moreover, an optimisation scenario evolved to optimise one particular circuit will often also produce superior results when applied to some other circuits, particularly if the initial target circuit is sufficiently challenging. For example, an optimisation scenario evolved to optimise one relatively small circuit may produce superior results even for some large circuits, and vice versa.

This all means that it is possible to develop by evolution a suite comprising a relatively small number of optimisation scenarios, which then facilitate trying each of those optimisation scenarios in turn on a new circuit to be optimised, and will in practice tend to give an improved optimisation performance than, for example, the known, standard, general-purpose optimisation scenarios that already exist.

The Applicants have also found that independently evolved optimisation scenarios for the same target circuit can have different sets of auxiliary circuits, and equally two different optimisation scenarios each evolved to optimise a different target circuit can again have very different sets of auxiliary circuits. This means that it is generally possible for the union of the auxiliary circuits of only a few evolved specialist optimisation scenarios to in practice cover and provide improved performance for many circuits.

Furthermore, modifying an evolved optimisation scenario, for example to remove redundant commands, can also change the auxiliary set of circuits for the optimisation scenario. Similarly, optimisation scenarios from part way through an evolutionary run may have a different set of auxiliary circuits for which they provide improved optimisation performance as compared to the final end result of the evolutionary run that is fully honed to its specialist target circuit.

1-55. (canceled)

56. A method of producing a suite of optimisation scenarios for use in the automated design of electronic circuits, comprising:
using an evolutionary algorithm or algorithms to evolve an optimisation scenario for each of a plurality of different electronic circuits; and
including one or more of the optimisation scenarios evolved for the different circuits in a suite of optimisation scenarios for use to optimise electronic circuits during their design.

57. The method of claim 56, comprising evolving a single optimisation scenario for a set of plural individual circuits.

58. The method of claim 56, comprising evolving plural optimisation scenarios for the same circuit or group of circuits.

59. The method of claim 56, comprising:
assessing whether an evolved optimisation scenario can be used to optimise an electronic circuit or circuits other than the circuit it was evolved for; and
including the optimisation scenario or not in the suite of optimisation scenarios to use on the basis of that assessment.

60. The method of claim 56, comprising selecting for inclusion in the suite of optimisation scenarios an optimisation scenario or scenarios from part way through an evolutionary run.

61. The method of claim 56, further comprising:
carrying out optimisations of an aspect of the design of an electronic circuit to be optimised using two or more optimisation scenarios from the suite of plural optimisation scenarios; and
selecting one of the optimisation results determined from the plural optimisations as the optimisation to use for the aspect of the circuit design.

62. The method of claim 61, comprising:
using an optimisation scenario that has been derived for a particular target circuit to carry out an optimisation for a circuit that is different to the target circuit.

63. A method of optimising an electronic circuit to be designed, the method comprising:
using an optimisation scenario that has been derived for a particular target circuit to optimise a circuit that is different to the target circuit.

64. The method of claim 62, comprising:
executing the optimisation scenario in a different manner when optimising the circuit that is not the target circuit to the manner of execution of the optimisation scenario for the target circuit for which it has been derived.

65. An apparatus for producing a suite of optimisation scenarios for use in the automated design of electronic circuits, comprising:
a processor for using an evolutionary algorithm or algorithms to evolve an optimisation scenario for each of a plurality of different electronic circuits; and
a processor for providing one or more of the optimisation scenarios evolved for the different circuits as a suite of optimisation scenarios for use to optimise electronic circuits during their design.

66. The apparatus of claim 65, comprising a processor for evolving a single optimisation scenario for a set of plural individual circuits.

67. The apparatus of claim 65, comprising a processor for evolving plural optimisation scenarios for the same circuit or group of circuits.

68. The apparatus of claim 65, comprising:
a processor for assessing whether an evolved optimisation scenario can be used to optimise an electronic circuit or circuits other than the circuit it was evolved for; and
a processor for including the optimisation scenario or not in the suite of optimisation scenarios to use on the basis of that assessment.

69. The apparatus of claim 65, comprising a processor for selecting for inclusion in the suite of optimisation scenarios an optimisation scenario or scenarios from part way through an evolutionary run.

70. The apparatus of claim 65, further comprising:
a processor for carrying out optimisations of an aspect of the design of an electronic circuit to be optimised using two or more optimisation scenarios from the suite of plural optimisation scenarios; and
a processor for selecting one of the optimisation results determined from the plural optimisations as the optimisation to use for the aspect of the circuit design.

71. The apparatus of claim 70, comprising:
a processor for using an optimisation scenario that has been derived for a particular target circuit to carry out an optimisation for a circuit that is different to the target circuit.

72. An apparatus for optimising an electronic circuit to be designed, the apparatus comprising:
a processor for using an optimisation scenario that has been derived for a particular target circuit to optimise a circuit that is different to the target circuit.

73. The apparatus of claim 71, comprising:
a processor for executing the optimisation scenario in a different manner when optimising the circuit that is not the target circuit to the manner of execution of the optimisation scenario for the target circuit for which it has been derived.

74. A method of constructing an electronic circuit, comprising:
using an evolutionary algorithm or algorithms to evolve an optimisation scenario for each of a plurality of different electronic circuits;
including two or more of the optimisation scenarios evolved for the different circuits in a suite of optimisation scenarios for use to optimise electronic circuits during their design;
carrying out optimisations of an electronic circuit to be optimised using two or more optimisation scenarios from the suite of plural optimisation scenarios;
selecting one of the optimisation results determined from the plural optimisations as the optimisation to use for the circuit; and
designing and constructing an electronic circuit using the selected circuit optimisation.

75. An electronic circuit that has been constructed by:
using an evolutionary algorithm or algorithms to evolve an optimisation scenario for each of a plurality of different electronic circuits;
including two or more of the optimisation scenarios evolved for the different circuits in a suite of optimisation scenarios for use to optimise electronic circuits during their design;
carrying out optimisations of an electronic circuit to be optimised using two or more optimisation scenarios from the suite of plural optimisation scenarios; and
selecting one of the optimisation results determined from the plural optimisations as the optimisation to use for the circuit; and
designing and constructing an electronic circuit using the selected circuit optimisation.

76. A computer program comprising computer software code portions for performing the method of claim 56 when the program is run on a data processor.
